(19) United States
(12) Patent Application Publication
(10) Pub. No.: US 2025/0045584 A1
(43) Pub. Date: Feb. 6, 2025

(54) METHOD AND SYSTEM OF COMPRESSING NEURAL NETWORK MODELS BASED ON LEARNABLE MULTI-CRITERIA

(71) Applicant: L&T TECHNOLOGY SERVICES LIMITED, Chennai (IN)

(72) Inventors: SURESH GUNASEKARAN, Tiruvannamalai (IN); VIKRAM SUBRAMANI, Krishnagiri (IN); SUDHIR BHADAURIA, Ahmedabad (IN); SANTHIYA RAJAN, Coimbatore (IN)

(21) Appl. No.: 18/434,891

(22) Filed: Feb. 7, 2024

(30) Foreign Application Priority Data
Aug. 1, 2023 (IN) 202341051704

(51) Int. Cl. G06N 3/082; G06N 3/0495

(52) U.S. Cl. CPC G06N 3/082; G06N 3/0495

(57) ABSTRACT

A method and system of compressing a neural network model (NNM) is disclosed. The method includes determining a set of criteria-based filters in a corresponding layer. The set of criteria-based filters are determined based on determination of a weighted criteria score for each of the plurality of predefined evaluation criteria. A cumulative weighted score for each of the first set of filters is determined based on a summation of each of the corresponding weighted criterion score. A second set of filters equal to a predefined number of filters to be removed from the set of criteria is determined based on the cumulative weighted score for each of the first set of filters. The NNM is compressed based on the second set of filters for each of the plurality of layers.

### TECHNICAL FIELD

This disclosure relates generally to neural networks, and more particularly to a method and a system of compressing neural network models based on learnable multi-criteria.

### BACKGROUND

The main challenge with using current state of the art Artificial Intelligence (AI) for real time applications is that the deployment devices are resource constrained. The deployment devices may be smartphones, single board computers, micro controllers, drones, wearables, smartphones, etc. having constraints with respect to memory and processing power. Since, most portable deployment devices may be designed to be light weight and may thus have less storage capacity, less processing capacity. Also, most portable devices are powered by batteries and cannot afford high computational tasks which may cause excessive battery usage and may lead to rapid discharging of the battery. Pruning methodologies are used to reduce the size of the neural networks. However, pruning is to be implemented after training of the model or during training of the model. However, pruning of the model is dependent on the selection criterion for selection of unimportant filters. A single selection criterion cannot be used for selection of unimportant filters for the entire model. Current pruning techniques involve manual selection of selection criterion for removal of less important filters. Further, the selection of criterion must be selected manually every time a new architecture and new data set is updated for the application. This makes compressing the NNM a very manual and time-consuming process.

Therefore, there is a requirement for an efficient methodology to compress neural network models based on determination of model based criteria.

### SUMMARY OF THE INVENTION

In an embodiment, a method of compressing a neural network model (NNM) is disclosed. The method may include, receiving, by a computing device, a predefined number of filters to be removed in each of a plurality of layers of the NNM. In an embodiment, each of the plurality of layers may include a first set of filters in a first sequence. The computing device may further receive a plurality of predefined evaluation criteria. Further, for each of a plurality of layers of the NNM, the computing device may determine a set of criteria based filters in a corresponding layer, based on each of predefined evaluation criteria. The computing system may determine for each of the first set of filters, a weighted criteria score for each of the plurality of predefined evaluation criteria based on criteria-based scores of each of the first set of filters and weights assigned to each of the plurality of predefined evaluation criteria. The computing device may further determine for each of the first set of filters, a cumulative weighted score based on a summation of each of the weighted criterion score corresponding to each of the plurality of predefined evaluation criteria. In an embodiment, the set of criteria based filters may be sorted based on the cumulative weighted score in order to arrange the set of criteria based filters in a second sequence. The computing device may further determine a second set of filters equal to the predefined number of filters to be removed from the sorted set of criteria based filters. Accordingly, the computing device may compress the NNM based on the second set of filters for each of the plurality of layers by pruning or removing the second set of filters from each of the plurality of layers.

In another embodiment, a system of compressing a neural network model (NNM) is disclosed. The system may include a processor, a memory communicably coupled to the processor, wherein the memory may store processor-executable instructions, which when executed by the processor may cause the processor to receive a predefined number of filters to be removed in each of a plurality of layers of the NNM. In an embodiment, each of the plurality of layers may include a first set of filters in a first sequence. The computing device may further receive a plurality of predefined evaluation criteria. The processor may further determine, for each of a plurality of layers of the NNM, a set of criteria based filters in a corresponding layer, based on each of predefined evaluation criteria. The processor may determine for each of the first set of filters, a weighted criteria score for each of the plurality of predefined evaluation criteria based on criteria-based scores of each of the first set of filters and weights assigned to each of the plurality of predefined evaluation criteria. The processor may further determine for each of the first set of filters a cumulative weighted score based on a summation of each of the weighted criterion score corresponding to each of the plurality of predefined evaluation criteria. In an embodiment, the set of criteria based filters may be sorted based on the cumulative weighted score in order to arrange the set of criteria based filters in a second sequence. The computing device may further determine a second set of filters equal to the predefined number of filters to be removed from the sorted set of criteria based filters. The processor may compress the NNM based on the second set of filters for each of the plurality of layers.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of an exemplary neural network model (NNM) compression system, in accordance with some embodiments of the present disclosure.

FIG. 2 illustrates a functional block diagram of the compression device, in accordance with some embodiments of the present disclosure.

FIG. 3 illustrates a flowchart depicting a methodology of compressing the neural network model, in accordance with some embodiments of the present disclosure.

FIG. 4 illustrates a flowchart of a method of compressing neural network models, in accordance with some embodiments of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

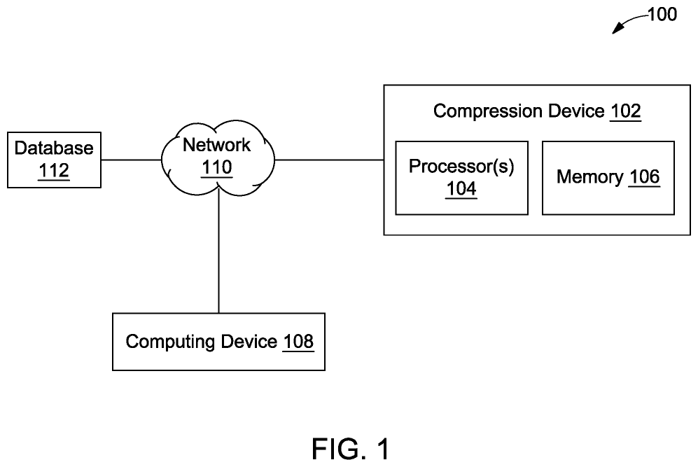

Referring now to FIG. 1, a block diagram of an exemplary neural network model (NNM) compressing system, in accordance with some embodiments of the present disclosure. The NNM compressing system 100 may include a compression device 102, a computing device 108, a database 112 communicably coupled to each other through a wired or a wireless communication network 110. The compression device 102 may include a processor 104 and a memory 106. In an embodiment, examples of processor(s) 104 may include, but are not limited to, an Intel® Itanium® or Itanium 2 processor(s), or AMD® Opteron® or Athlon MP® processor(s), Motorola® lines of processors, Nvidia®, FortiSOC™ system on a chip processors or other future processors. The memory 106 may store instructions that, when executed by the processor 104, cause the processor 104 to compress the neural network models (NNM). The memory 106 may be a non-volatile memory or a volatile memory. Examples of non-volatile memory may include but are not limited to a flash memory, a Read Only Memory (ROM), a Programmable ROM (PROM), Erasable PROM (EPROM), and Electrically EPROM (EEPROM) memory. Examples of volatile memory may include but are not limited to Dynamic Random Access Memory (DRAM), and Static Random-Access memory (SRAM).

In an embodiment, the database 112 may be enabled in a cloud or physical database comprising data such as predefined evaluation criteria corresponding to various types of NNM being deployed on the computing device 108 or the compression device 102. In an embodiment, the database 112 may store data input to or generated by the computing device 108 or generated by the compression device 102.

In an embodiment, the communication network 110 may be a wired or a wireless network or a combination thereof. The network 110 can be implemented as one of the different types of networks, such as but not limited to, ethernet IP network, intranet, local area network (LAN), wide area network (WAN), the internet, Wi-Fi, LTE network, CDMA network, 5G and the like. Further, network 110 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further network 110 can include a variety of network devices, including routers, bridges, servers, computing devices, storage devices, and the like.

In an embodiment, the compression device 102 and the computing device 108 may be same or may be integrated to each other. In an embodiment, the computing device 108 may be a computing system, including but not limited to, a smart phone, a laptop computer, a desktop computer, a notebook, a workstation, a portable computer, a personal digital assistant, a handheld, a scanner, or a mobile device. In an embodiment, the compression device 108 may be implemented on the computing device 108 and the processor 104 may perform one or more steps for compression of the NNM as described in detail below.

In an embodiment, a neural network model may include interconnection of numerous neurons to form an architecture. In an embodiment, neurons may also be interchangeably referred to as filters. In an embodiment, different techniques for model compression may be used such as, but not limited to, pruning, quantization, factorization and knowledge distillation, and so on. In an embodiment, pruning may be the process of removing less important or redundant neurons in an NNM that may not contribute much to the accuracy of the network. However, pruning may reduce the computational complexity of the network and may make the NNM less device resource intensive. Further, different types of pruning may be performed such as structured and unstructured, depending on shape of neurons to be pruned. Further, depending on the time at which pruning is performed static or dynamic pruning may be performed. Further, based on a pruning ratio, local or global pruning may be performed.

In an embodiment, the NNMs may be pruned using global pruning methodology or local pruning methodology. In an embodiment, local pruning methodology is a type of pruning technique wherein a predefined number of neurons/connections of the NNM may be removed from all layers in the networks. For example, in case a local pruning ratio is predefined to be 20%, then local pruning may remove 20% of neurons in each of the layers in the model.

In another embodiment, the global pruning methodology is a type of pruning technique in which all parameters across all layers may be combined and a predefined fraction of the neurons/connections are selected randomly for pruning. For example, in case a global pruning ratio is predefined to be 20%, then global pruning may remove 20% of neurons in all of the layers in the network.

Further, in the case of pruning based on global pruning ratio, selection of number of filters to be removed from each layer is very critical to the accuracy of the NNM. In an exemplary embodiment, in case one filter is removed from one of the depth layers of a VGG16 model, may cause reduction of 9216 parameters and 14.5 million FLOPs. However, in another scenario, in case filters are removed from one of the middle layers of the VGG16 model, there may be reduction of same number of parameters i.e., 9216 but reduction of 57.8 million FLOPs. Accordingly, the reduction of computational cost varies greatly based on selection of filters from the types of layers.

In an embodiment, pruning may be defined as removal of less important filters in a neural network and may be classified into three types. The first type may include removal of the unimportant filters from a trained model which may be fine-tuned later. Accordingly, the architecture may again be retrained for a certain number of epochs. Further, the second type of pruning may involve removal of unimportant filters during the training of the NNM without the requirement of fine tuning based on selection of importance evaluation criteria during the training. The third type may include removal of the unimportant filters in the architecture without the fine tuning. The type of pruning that may be opted for may depend on the application and availability of data.

In a preferred embodiment, in all three types of pruning, the filters to be removed may be selected based on an importance evaluation criteria. Accordingly, based on the importance evaluation criteria the filters to be removed from each layer may be determined. The efficiency of pruning may depend on how well the criteria may be selected for different applications and data sets. It is to be noted that efficiency of pruning is hampered in cases when a single criterion may be used for selecting the unimportant filters across the complete model. Further, all criteria may not apply for all the layers and therefore are to be selectively used across the model since it may be difficult to identify which criteria to be used at particular segment of the complete architecture. The current disclosure provides an efficient methodology to compress neural network models based on learnable criteria making it more efficient.

By way of an example, the processor 104 may receive a predefined number of filters to be removed in each of a plurality of layers of the NNM based on a predefined global pruning ratio. The each of the plurality of layers may include a first set of filters arranged in a first sequence. In an embodiment, the first set of filters in each of the plurality of layers may be determined based on a training of the NNM. In an embodiment, the NNM may be, but not limited to, a CNN based model. The processor 104 may further receive a plurality of predefined evaluation criteria. The each of the plurality of predefined evaluation criteria may correspond to at least one type of feature extracted by the NNM. The processor 104 may determine criterion-based scores for each filter from the first set of filters based on the at least one type of feature extracted by the NNM corresponding to each of the plurality of predefined evaluation criteria. Further, the processor may determine a weighted criteria score for each of the plurality of predefined evaluation criteria based on the criterion-based scores of each of the first set of filters and predefined weights assigned to each of the plurality of predefined evaluation criteria. In an embodiment, in a training phase of the NNM, for each layer of the NNM, weight, feature maps and bias may be determined separately and used to determine the criterion-based scores for each of the first set of filters of each of the plurality of layers. In an embodiment, the first set of filters or the feature map are passed through each of the predefined evaluation criteria for qualitatively analysing the information present in each of the first set of filters. In an embodiment, the predefined importance evaluation criterion can be any technique like singular value based pruning, Eigen value, etc.

In an embodiment, the weighted criteria score for each of the first set of filters for each of the plurality of predefined evaluation criteria may be determined based on a dot product of the criterion-based scores of the corresponding filter and the weights assigned to each of the corresponding predefined evaluation criteria.

In an embodiment, the weights assigned to each of the plurality of predefined redundancy criteria may be learned based on optimization of predefined weights, assigned to each of the predefined evaluation criteria based on determination of a validation loss of the NNM using gradient-descent back propagation technique during model prediction of the NNM. In an embodiment, the predefined weights of each of the plurality of predefined evaluation criteria may be determined based on one or more initialization techniques.

In an embodiment, a cumulative weighted score may be determined by the processor 104 based on a summation of each of the weighted criterion score corresponding to each of the plurality of predefined evaluation criteria. The processor 104 may determine a normalized cumulative weighted score for each of the first set of filters based on the cumulative weighted score. Further, the predefined weights may be optimized by the processor 104 by adding a bias of a corresponding layer to the normalized cumulative weighted score. In an embodiment, the weights assigned of each of the plurality of the predefined evaluation criteria may be in a range of 0 to 1.

Further, the set of criteria based filters may be sorted based on the cumulative weighted score. Accordingly, criteria based filters may be sorted in order to be arranged in the second sequence based on an ascending order or a descending order of the cumulative weighted score of each of the first set of filters.

Further, the processor 104 may determine a second set of filters equal to the predefined number of filters to be removed from the sorted set of criteria based filters. The processor may further compress the NNM based on the second set of filters determined for each of the plurality of layers.

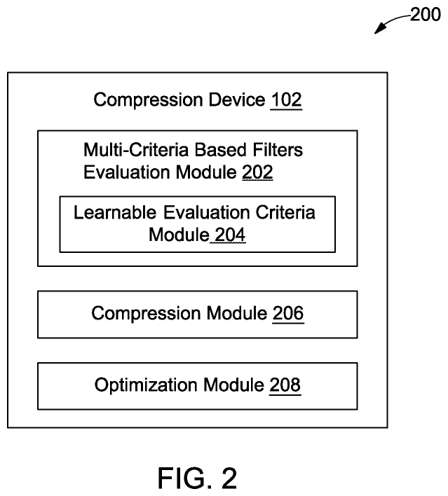

Referring now to FIG. 2, a functional block diagram of the compression device, in accordance with some embodiments of the present disclosure. The compression device 102 may include a multi-criteria based filter evaluation module 202 and a learnable evaluation criteria module 204, a compression module 206 and an optimization module 208.

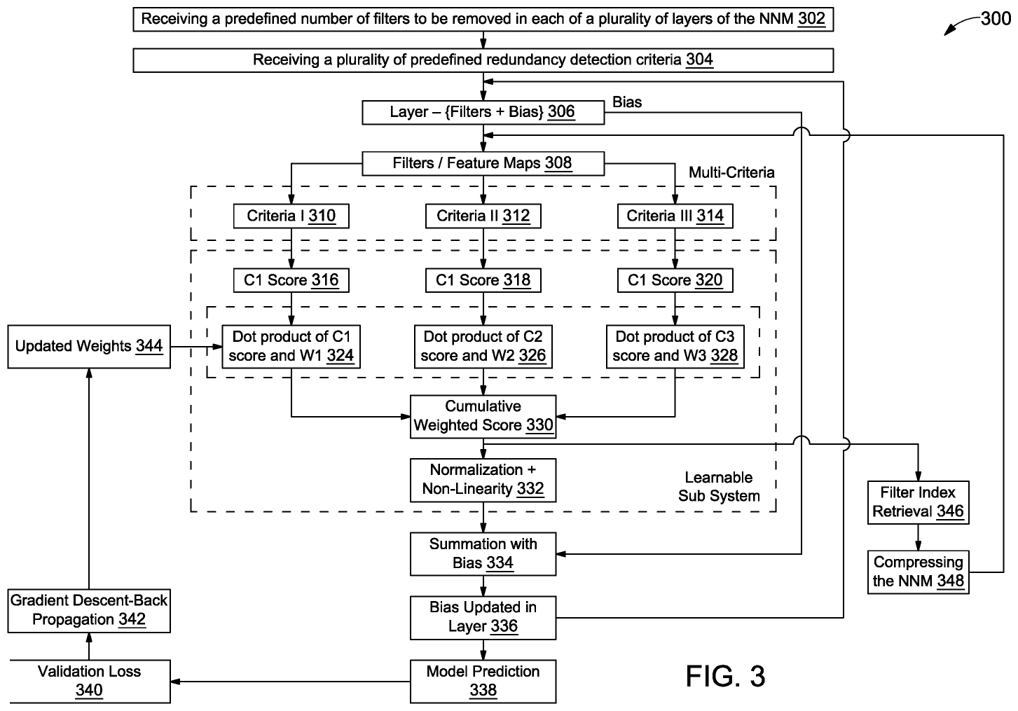

FIG. 3 illustrates a flowchart depicting a methodology of compressing the neural network model, in accordance with some embodiments of the present disclosure. The description of modules of FIG. 2 is provided in conjunction with the description of FIG. 3 below. The flowchart 300 may include a plurality of steps that may be performed by the compression device 102 to compress the neural network models.

At step 302, the compression device 102 may receive the predefined number of filters to be removed in each of the plurality of layers of the NNM. In an embodiment, the NNM may be deployed on the compression device 102 or the computing device 108. In an embodiment, the NNM being deployed may be, but not limited to, a CNN based model. The NNM may include a plurality of layers, which in turn may each include a first set of filters arranged in a first sequence. In an embodiment, the first set of filters in each of the plurality of layers may be determined during the training of the NNM. In general, the NNM may be trained based on a large amount of training data in order for the architecture to learn to detect a plurality of features on its own. Accordingly, based on the training of the NNM, weights of some unimportant filters may also be set as high which may not be very important for the accuracy of the NNM.

In an embodiment, during calibration of the trained NNM, the predefined number of filters to be removed in each of a plurality of layers of the NNM may be determined based on a predefined global pruning ratio or based on determination of filters to be pruned based on methodology described in co-filed patent application titled “METHOD AND SYSTEM OF COMPRESSING NEURAL NETWORK MODELS” incorporated herein in its entirety by reference. In an embodiment, in order to remove a predefined number of filters in each layer based on local pruning ratio, selection of filters in each layer is crucial in order to remove only redundant filters such that the accuracy of the NNM is not compromised.

Further at step 304, the multi-criteria based filter evaluation module 202 may receive a plurality of predefined evaluation criteria. In an embodiment, a plurality of predefined evaluation criteria may be predefined based on the type of data and type of requirement or processing performed by the NNM. In an embodiment, each of the plurality of predefined evaluation criteria may correspond to at least one type of feature extracted by the NNM.

Further at step 306, the multi-criteria based filter evaluation module 202 may determine a bias of a corresponding layer. In an embodiment, the bias of each of the corresponding layer may be predefined or predetermined. Further at step 308, weights and feature maps of each of the first set of filters of the corresponding layer may be determined. In an embodiment, the feature maps may be determined based on test input. Further at step 308, the multi-criteria based filter evaluation module 202 may evaluate each of set of the filters or the corresponding feature maps of each of the set of the filters through each of the predefined evaluation criteria.

Further, the steps 316, 318, 320, 324, 326, 328, 330 and 332 may be performed by the learnable evaluation criteria module 204. In an exemplary embodiment, as depicted in FIG. 3, each of the set of the filters or the corresponding feature maps of each of the set of the filters may be qualitatively analyzed based on three criteria C1, C2 and C3 at steps 310, 312 and 314 respectively, based on the information present in the filters. At steps 316, 318 and 320, criterion-based scores for each filter from the first set of filters may be determined based on the at least one type of processing performed by the NNM corresponding to each of the plurality of predefined evaluation criteria C1, C2 and C3. Accordingly, at steps 316, 318 and 320 may return a normalised criterion based scores based on each of the evaluation criteria C1, C2 and C3 and the first set of filters may be listed based on a descending order of their normalised criterion based scores. In an embodiment, an evaluation criterion can be any technique such as, but not limited to, singular value based pruning, such as, but not limited to, Eigen value, etc.

At steps 324, 326 and 328, a weighted criteria score may be determined for each filter from the first set of filters based on a dot product of the criterion-based scores of the corresponding filter and the weights assigned to each of the corresponding predefined evaluation criteria C1, C2 and C3. In an embodiment, the weights W1, W2 and W3 may be assigned to each of the evaluation criteria C1, C2 and C3 respectively. In an embodiment, the weights W1, W2 and W3 assigned of each of the plurality of predefined evaluation criteria C1, C2 and C3 respectively may be in a range of 0 to 1. In an embodiment, the weights W1, W2 and W3 may be initialized during the training of the NNM based on distribution techniques such as, but not limited to, binomial distribution, Gaussian distribution, He, Xavier, Lacuna, etc. In an embodiment, the weights may be initialized during training of the NNM and updated based on back propagation of the NNM. A weight assigned to each of the predefined evaluation criterion may be indicative of a significance or importance of the corresponding criterion for evaluation of importance of each of the first set of filters in a particular layer of the NNM. It is to be noted that, positioning of a particular layer is an important factor in determining the significance or importance of the first set of filters of the layer. Accordingly, the position of the layer in a given architecture is indicative of the different types of features extracted by the first set of filters of the layer. Accordingly, in case a weight of a particular criterion has value “0” then the significance of that particular criterion is least in determination of the importance of filters of a particular layer. Further, in case a weight of a particular criterion has value “1” then the significance of that particular criterion is highest in determination of the importance of filters of a particular layer. In an embodiment, the weights assigned to each of the first set of filters in each of the plurality of layers of the NNM may vary from one layer to another.

Further at step 330, the learnable evaluation criteria module 204 may determine a cumulative weighted score of each of the first set of filters based on a summation of each of the weighted criterion scores corresponding to each of the plurality of predefined evaluation criteria. For example, at steps 324, 326 and 328, the weighted criteria scores of each of the filters indexed as 1-10 may be evaluated. Further, the weighted criteria scores of each of the filters 1-10 may be summed for all the predefined evaluation criteria C1, C2 and C3. Accordingly, a filter indexed as “1” may have a first weighted criteria score based on criterion C1 and weight W1 determined at step 324. Similarly, the filter indexed as “1” may have a second weighted criteria score based on criterion C2 and weight W2 determined at step 326 and a third weighted criteria score based on criterion C3 and weight W3 determined at step 328. Further, the cumulative weighted score of the filter indexed as “1” may be determined as summation of the first weighted criteria, the second weighted criteria and the third weighted criteria score. Accordingly, at step 346, the compression module 206 may sort the first set of filters by arranging the filters in descending order or ascending order of their corresponding cumulative weighted scores in order to arrange the first set of filters in a second sequence. At step 348, the compression module 206 may select predefined number of filters to be removed from the sorted first set of filters arranged in the second sequence by selecting the filters with lower cumulative weighted scores determined for a corresponding layer. Accordingly, a second set of filters are selected for a corresponding layer for compressing the NNM by selecting the predefine number of filters to be removed from the sorted first set of filters which have less cumulative weighted scores.

Further at step 332, the learnable evaluation criteria module 204 may normalize the cumulative weighted scores, determined at step 330, based on an activation function such as, but not limited to, REL function, sigmoid function, etc. At step 334, the output from the step 332 is added with a bias determined at step 306. Further at step 336, the bias of the corresponding layer may be determined. In an embodiment, bias of each layer may be predefined or predetermined. Accordingly, the learnable evaluation criteria module 204 may repeat the steps 306-336 for each the plurality of layers of the NNM in order to determine a second set of filters in each of the layers. Accordingly, when the NNM is being trained, bias of each of the layers may be updated or learned using gradient descent back propagation. Accordingly, through the bias, the newly introduced filters will be updated or learned. Further, the compression module 206 may repeat the steps 308-330 and steps 346 and 348 in order to compress the NNM by removing the second set of filters from the first set of filters for each of the plurality of layers of the NNM.

At step 338, the optimization module 208 may perform model prediction by comparing an output of the NNM with ground truth value. Based on the model prediction performed in step 336, a validation loss may be determined by the optimization module 208 at step 340. The validation loss may be determined based on a loss function. Further at step 342, the obtained validation loss at step 340 may be used to optimize the first set of filters or optimize the weights of the first set of filters in order to minimize the validation loss using a gradient descent algorithm. Accordingly, based on the output of the step 342, the weights assigned to each of the plurality of predefined evaluation criteria may be updated at step 344. Accordingly, the updated weights in step 344 may be used for evaluation of weighted criteria scores of the first set of filters in next iteration performed by the multi-criteria based filter evaluation module 202 and the learnable evaluation criteria module 204 to determine the second set of filters to compress the NNM at step 348. Further, the optimization module 208 may also utilize the updated weights in step 344 to optimize the NNM based on pruning of the NNM based on removal of the second set of filters in each of the plurality of layers.

Accordingly, the weights W1, W2 and W3 assigned to each of the plurality of predefined evaluation criteria C1, C2 and C3 may be initially predefined or initiated and are updated based on continuous learning based on optimization performed by the optimization module 208. The updated weights determined at step 344 are assigned to each of the predefined evaluation criteria based on determination of a validation loss of the NNM using gradient-descent back propagation technique during model prediction of the NNM.

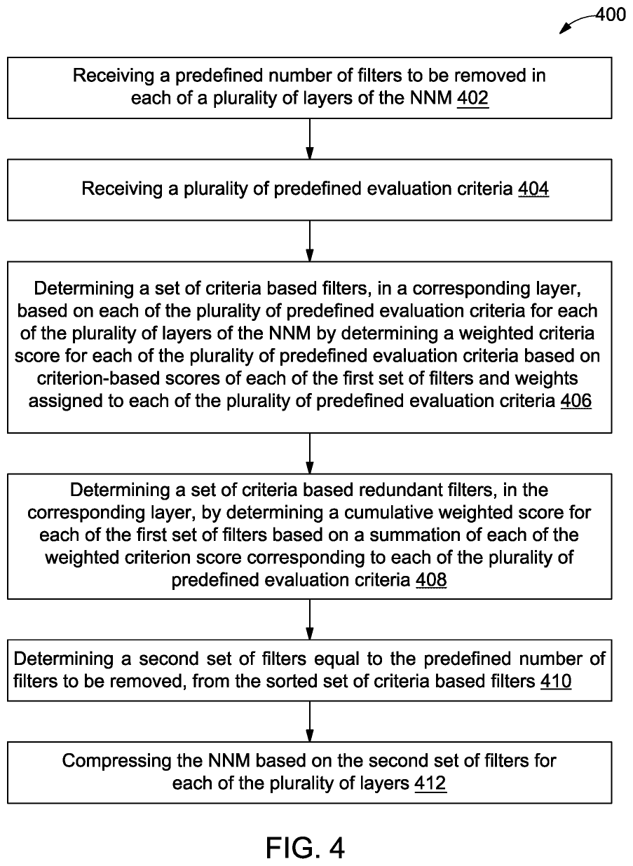

Referring now to FIG. 4, a flowchart 400 depicting a method of compressing neural network models is shown, in accordance with some embodiments of the present disclosure. In an embodiment, method 400 may include a plurality of steps that may be performed by the processor 104 to compress the neural network models.

At step 402, the processor 104 may receive a predefined number of filters to be removed in each of a plurality of layers of the NNM. In an embodiment, each of the plurality of layers may include a first set of filters in a first sequence.

Further at step 404, the processor 104 may receive a plurality of predefined evaluation criteria. The each of the plurality of predefined evaluation criteria may correspond to at least one type of feature extracted by the NNM. At step 406, for each of the first set of filters of a corresponding layer of the NNM, criterion-based scores may be determined based on each of the predefined evaluation criteria. In an embodiment, each of the predefined evaluation criteria corresponds to at least one type of feature extracted by the NNM. Further, at step 406, a weighted criteria score may be determined for each of the first set of filters of a corresponding layer based on each of the plurality of predefined evaluation criteria. In an embodiment, the weighted criteria score may be determined based on a dot product of criterion-based scores of the each of the first set of filters and the weights assigned to each of the corresponding predefined evaluation criteria.

Further at step 408, the processor 104 may determine a set of criteria based filters in a corresponding layer, based on determination of a cumulative weighted score of each of the first set of filters. In an embodiment, the cumulative weighted score of each of the first set of filters may be determined based on a summation of each of the weighted criterion score corresponding to each of the plurality of predefined evaluation criteria. The set of criteria based filters may be arranged in a second sequence based on an ascending order or a descending order of the cumulative weighted score of each of the first set of filters.

Further at step 410, the processor 104 may determine a second set of filters equal to the predefined number of filters to be removed from the set of criteria based filters.

Further at step 412, the processor 104 may compress the NNM based on the second set of filters for each of the plurality of layers.

accordingly, the compression of the NNM may be based on the removal of the second set of filters. The second set of filters may be removed from the first set of filters and the NNM may be fine tuned based on knowledge distillation-based techniques. It is intended that the disclosure and examples be considered as exemplary only, with a true scope of disclosed embodiments being indicated by the following claims.

What is claimed is:

1. A method of compressing a neural network model (NNM), the method comprising:
receiving, by a computing device, a predefined number of filters to be removed in each of a plurality of layers of the NNM,
wherein each of the plurality of layers comprises a first set of filters in a first sequence;
receiving, by the computing device, a plurality of predefined evaluation criteria;
for each of a plurality of layers of the NNM:
determining, by the computing device, a set of criteria based filters, in a corresponding layer, based on each of the plurality of predefined evaluation criteria by:
for each of the first set of filters:
determining, by the computing device, a weighted criteria score for each of the plurality of predefined evaluation criteria based on criterion-based scores of each of the first set of filters and weights assigned to each of the plurality of predefined evaluation criteria; and
determining, by the computing device, a cumulative weighted score based on a summation of each of the weighted criterion score corresponding to each of the plurality of predefined evaluation criteria,
sorting the set of criteria based filters in a second sequence based on the cumulative weighted score;
determining, by the computing device, a second set of filters equal to the predefined number of filters to be removed, from the sorted set of criteria based filters; and
compressing, by the computing device, the NNM based on the second set of filters for each of the plurality of layers.

2. The method of claim 1, wherein each of the plurality of predefined evaluation criteria correspond to at least one type of feature extracted by the NNM,
wherein for each filter from the first set of filters:
the criterion-based scores are determined based on the at least one type of feature extracted by the NNM corresponding to each of the plurality of predefined evaluation criteria, and
the weighted criteria score is determined for each of the plurality of predefined evaluation criteria is determined based on a dot product of the criterion-based scores of the corresponding filter and the weights assigned to each of the corresponding predefined evaluation criteria.

3. The method of claim 1, wherein the weights assigned to each of the plurality of predefined evaluation detection criteria are learned based on:
optimization of predefined weights, assigned to each of the corresponding predefined evaluation criteria, based on determination a validation loss of the NNM using a gradient-descent back propagation technique during a model prediction of the NNM,
wherein the predefined weights of each of the plurality of predefined evaluation criteria are determined based on one or more initialization techniques.

4. The method of claim 3, wherein the optimization of the predefined weights comprises:
determining, by the computing device, a normalized cumulative weighted score for each of the first set of filters based on the cumulative weighted score; and
adding, by the computing device, the normalized cumulative weighted score to a bias of a corresponding layer.

5. The method of claim 1, wherein the weights assigned to each of the plurality of predefined evaluation criteria is in a range of 0 to 1.

6. The method of claim 1, wherein the set of criteria based filters are sorted in the second sequence based on one of an ascending order or a descending order of the cumulative weighted score of each of the first set of filters.

7. The method of claim 1, wherein the first set of filters in each of the plurality of layers are determined based on a training of the NNM.

8. A system of compressing a neural network model (NNM), the system comprising:
a processor; and
a memory communicably coupled to the processor, wherein the memory stores processor-executable instructions, which, on execution by the processor, cause the processor to:
receive a predefined number of filters to be removed in each of a plurality of layers of the NNM,
wherein each of the plurality of layers comprises a first set of filters in a first sequence;
receive a plurality of predefined evaluation criteria;
for each of a plurality of layers of the NNM:
determine a set of criteria based filters, in a corresponding layer, based on each of the plurality of predefined evaluation criteria based on:
for each of the first set of filters:
determination of a weighted criteria score for each of the plurality of predefined evaluation criteria based on criterion-based scores of each of the first set of filters and weights assigned to each of the plurality of predefined evaluation criteria; and
determination of a cumulative weighted score based on a summation of each of the weighted criterion score corresponding to each of the plurality of predefined evaluation criteria,
sort the set of criteria based filters in a second sequence based on the cumulative weighted score;
determine a second set of filters equal to the predefined number of filters to be removed, from the sorted set of criteria based filters; and
compress the NNM based on the second set of filters for each of the plurality of layers.

9. The system of claim 8, wherein each of the plurality of predefined evaluation criteria correspond to at least one type of feature extracted by the NNM,
wherein for each filter from the first set of filters:
the criterion-based scores are determined based on the at least one type of feature extracted by the NNM corresponding to each of the plurality of predefined evaluation criteria, and
the weighted criteria score is determined for each of the plurality of predefined evaluation criteria is determined based on a dot product of the criterion-based scores of the corresponding filter and the weights assigned to each of the corresponding predefined evaluation criteria.

10. The system of claim 8, wherein the weights assigned to each of the plurality of predefined evaluation criteria are learned based on:
optimization of predefined weights, assigned to each of the corresponding predefined evaluation criteria, based on determination a validation loss of the NNM using gradient-descent back propagation technique during model prediction of the NNM,
wherein the predefined weights of each of the plurality of predefined evaluation criteria are determined based on one or more initialization techniques.

11. The system of claim 10, wherein the optimization of the predefined weights causes the processor to:
determine a normalized cumulative weighted score for each of the first set of filters based on the cumulative weighted score; and
add a bias of a corresponding layer to the normalized cumulative weighted score.

12. The system of claim 8, wherein the weights assigned of each of the plurality of the plurality of predefined evaluation criteria is in a range of 0 to 1.

13. The system of claim 8, wherein the set of criteria based filters are arranged in the second sequence based on one of an ascending order or a descending order of the cumulative weighted score of each of the first set of filters.

14. The system of claim 8, wherein the first set of filters in each of the plurality of layers are determined based on a training of the NNM.

15. A non-transitory computer-readable medium storing computer-executable instructions for compressing a neural network model (NNM), the computer-executable instructions configured for:
receiving a predefined number of filters to be removed in each of a plurality of layers of the NNM,
wherein each of the plurality of layers comprises a first set of filters in a first sequence;
receiving a plurality of predefined evaluation criteria;
for each of a plurality of layers of the NNM:
determining a set of criteria based filters, in a corresponding layer, based on each of the plurality of predefined evaluation criteria by:
for each of the first set of filters:
determining a weighted criteria score for each of the plurality of predefined evaluation criteria based on criterion-based scores of each of the first set of filters and weights assigned to each of the plurality of predefined evaluation criteria; and
determining a cumulative weighted score based on a summation of each of the weighted criterion score corresponding to each of the plurality of predefined evaluation criteria,
sorting the set of criteria based filters in a second sequence based on the cumulative weighted score;
determining a second set of filters equal to the predefined number of filters to be removed, from the sorted set of criteria based filters; and
compressing the NNM based on the second set of filters for each of the plurality of layers.

16. The non-transitory computer-readable medium of claim 15, wherein each of the plurality of predefined evaluation criteria correspond to at least one type of feature extracted by the NNM,
wherein for each filter from the first set of filters:
the criterion-based scores are determined based on the at least one type of feature extracted by the NNM corresponding to each of the plurality of predefined evaluation criteria, and
the weighted criteria score is determined for each of the plurality of predefined evaluation criteria is determined based on a dot product of the criterion-based scores of the corresponding filter and the weights assigned to each of the corresponding predefined evaluation criteria.

17. The non-transitory computer-readable medium of claim 15, wherein to learn the weights assigned to each of the plurality of predefined evaluation detection criteria the computer-executable instructions are configured to:
optimize predefined weights, assigned to each of the corresponding predefined evaluation criteria, based on determination a validation loss of the NNM using a gradient-descent back propagation technique during a model prediction of the NNM,
wherein the predefined weights of each of the plurality of predefined evaluation criteria are determined based on one or more initialization techniques.

18. The non-transitory computer-readable medium of claim 17, wherein the computer-executable instructions are configured to optimize the predefined weights by:
determining a normalized cumulative weighted score for each of the first set of filters based on the cumulative weighted score; and
adding the normalized cumulative weighted score to a bias of a corresponding layer.

19. The non-transitory computer-readable medium of claim 15, wherein the weights assigned to each of the plurality of predefined evaluation criteria is in a range of 0 to 1.

20. The non-transitory computer-readable medium of claim 15, wherein the set of criteria based filters are sorted in the second sequence based on one of an ascending order or a descending order of the cumulative weighted score of each of the first set of filters.
